(19) United States
(12) Patent Application Publication
(10) Pub. No.: US 2006/0011713 A1
(43) Pub. Date: Jan. 19, 2006

(54) Brazing method for achieving a mechanical and electrical connection between two pieces

(76) Inventor: Heinrich Liebisch, Marly (CH)

Correspondence Address: OLIFF & BERRIDGE, PLC, P.O. BOX 19928, ALEXANDRIA, VA, 22320, US

(21) Appl. No.: 10/535,095

(22) PCT Filed: Dec. 24, 2003
(86) PCT No.: PCT/CH03/00847

§ 371 Date: May 16, 2005

(51) Int. Cl. B23K 1/19

(52) U.S. Cl. 228/262.51; 228/4.1

(57) ABSTRACT

A brazing method for, through melting of a connecting agent then solidification of this connecting agent, achieving a mechanical and electrical connection between at least one first face (2), of a first piece (200), and at least one second face (3), of a second piece (300), said first piece (200) and said second piece (300) being constituents of an electro-technical device (4),
the first piece (200) being made starting from
   at least one first metallic material (202) in the form of a foil (201) of a given thickness, this first material (202) comprising a main constituent (203), referred to as the first main constituent (203), said first metallic material having a defined temperature of complete solidification (solidus) (T2), referred to as the first complete solidification temperature (T2), and at least one dielectric interfacing material,
the second piece (300), on the one hand, having, in a direction substantially orthogonal to the second face (3), a dimension (D) appreciably greater than the thickness (E) of the first metallic material (202) in foil form (201) making up the first piece (200), and, on the other hand, being composed of a metallic material (302), referred to as the second metallic material (302), comprising a main constituent (303), referred to as the second main constituent (303), at least substantially similar to the first main constituent (203) of the first metallic material (202), said second metallic material (302) likewise having a temperature of complete solidification (solidus) (T3), also defined, referred to as the second temperature of complete solidification (T3),
this brazing method being characterised in that used is a connecting agent made up beforehand of a metallic material (102) which, referred to as the third metallic material (102), comprises a main constituent (103), referred to as the third main constituent (103), at least substantially similar to the first main constituent (203), this third metallic material (102) having however a temperature of complete melting (liquidus) (T1) which is lower, on the one hand, than the first complete solidification temperature (T2), and, on the other hand, than the second complete solidification temperature (T3).

This invention relates to a brazing method for, through melting of a connecting agent then solidification of this connecting agent, achieving a mechanical and electrical connection between at least one first face, of a first piece, and at least one second face, of a second piece.

The invention also relates to electro-technical devices comprising at least one first piece and at least one second piece between which a mechanical and electrical connection is achieved according to the aforementioned brazing method.

The invention also relates to electro-technical devices, such as energy storage devices comprising electrodes and other parts, the electrodes and parts being connected together according to the afore mentioned brazing method.

The invention applies in particular to the field of electro-technical devices for the storage of electrical energy, such as capacitors, primary batteries (simple feed batteries) and secondary batteries (storage batteries). The invention likewise relates to electro-technical devices comprising parts between which a mechanical and electrical connection is achieved according to the invention.

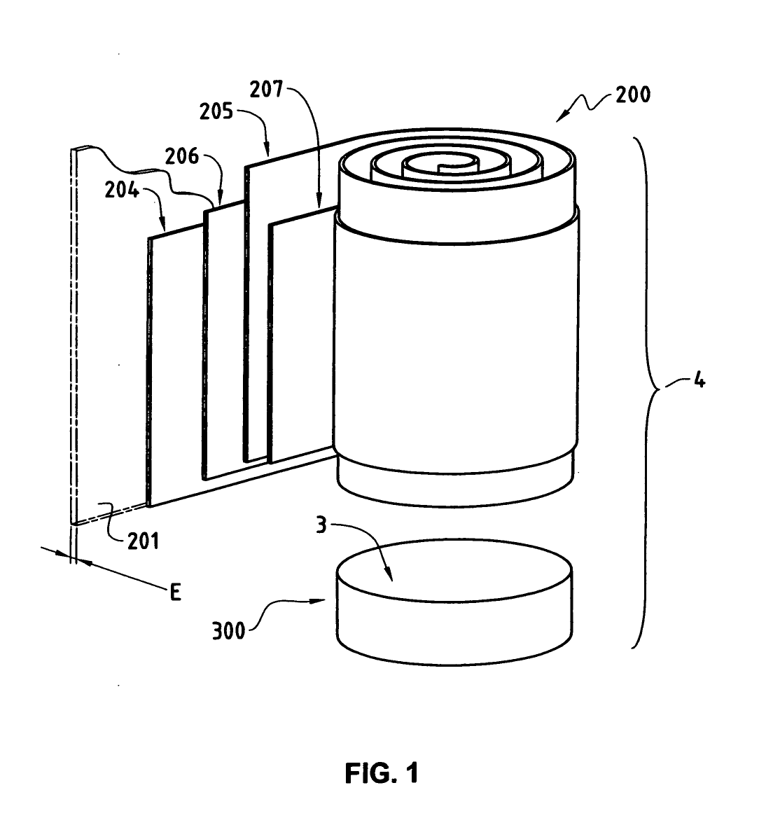

In the aforementioned field, one frequently encounters devices comprising:
a first piece (made up of two electrodes and two dielectrics elements as shown in FIG. 1) consisting of a group of two electrodes which, separated by at least one dielectric element, are each made starting from a conducting foil (for example of aluminium or of any other metal conductor) of very slight thickness (of four to fifty micrometers),
two other pieces, constituting electrical terminals, hereinafter referred to as second pieces, each intended to be connected mechanically and electrically to the first piece, and, to be more precise, to one of the electrodes it comprises.

Included by the phrase “made starting from a conducting foil of very slight thickness” is the case where the production is achieved starting from a continuous sheet of material.

For example, the first piece is constituted by achieving a stack or a spirally wound cylindrical coil by means of a plurality of superimposed bands, in particular four bands, of which there are
a first band taken from a foil of a first metallic material, comprising, in particular, aluminium,
a second band, likewise taken from a first metallic material foil, comprising, in particular, aluminium,
a third band and a fourth band made up of a porous or non-porous dielectric interfacing material, these bands being disposed to separate during and after winding, the first band from the second band.

When it is indicated that the first band and the second band are taken from a foil of a first metallic material, comprising, in particular, aluminium, this does not exclude one or the other of these bands bearing one or more layers of material of another nature.

The first piece may comprise two bands between which electrode materials separated by a dielectric material are disposed. The electrode materials may include one or more of known compositions of carbon, binder, and adhesive materials. For example, the electrode materials may include a mixture of active and/or conductive carbon particles, and/or a binder. A mixture of binder and conductive carbon particles may be deposited onto a band to provide an adhesion layer. Onto the adhesion layer, a layer of a mixture of binder, and active and/or conductive carbon particles may be further provided. One or more of the layers may be applied using spraying, lamination, coating, extrusion, or other process techniques. Accordingly, the present invention further applies to electro-technical devices that utilize carbon powder electrode technology. Double-layer capacitors and lithium batteries are one variety of electro-technical devices that may utilize carbon powder technology.

Each band therefore comprises two main opposite faces which, extending along the length of said band, are laterally delimited by two lateral faces, referred to as edges.

Before winding, the four bands are superimposed while being laterally offset in such a way that after winding the first band and the second band each have:
a free edge which extends in a spiral and constitutes a face between two opposite faces of the spiral winding, and
a non-accessible edge, constituted by an edge of the band situated inside the winding.

Considered further on will be that the winding under consideration is achieved in such a way that at least the first band has a free edge which extends in a spiral thus constituting an end face, referred to as first face.

The second piece is made up such that it has a second face able to be substantially superimposed on the first face of the first piece and having, in a direction substantially orthogonal to said second face, a dimension appreciably greater than the thickness of the metallic material in foil form used to produce the first piece.

Each of the end faces of the first piece are connected to a face of a second piece or terminal.

When the first piece comprises bands made up starting with foil of aluminium, the second piece or terminal is itself made up of aluminium or an aluminium alloy.

The very slight thickness of the first piece gives it a reduced capability to conduct heat.

The presence of the dielectric material makes the first piece heat-sensitive. The first piece is made up of an assembly of electrodes and dielectrics. The electrode acts as a heat sink, although with little transport capacity, bringing energy in the vicinity of the heat sensitive dielectric.

Also, in the field of capacitors, known to achieve a connection between a first piece, consisting of a group of electrodes, and a second piece, consisting of a terminal, is to proceed by soldering by means of a connecting agent consisting of tin or a tin alloy. The soldering with tin is carried out at low temperature (about two hundred thirty degrees Celsius) and gives satisfying results with respect to both the mechanical connection and the electrical connection, which it allows to be obtained.

However, this type of connection with tin in the presence of an ionic conductor (for example an electrolyte) induces electrolytic couples, which have a considerable impact upon the life of the capacitor. In fact, these electrolytic couples cause irreparable corrosion and a progressive local destruction of the capacitor.

The performance requirements placed by users upon capacitors sensitive to electrolytic couples has led manufacturers to reject the method of soldering with tin in favour of a mechanical assembling method.

Because capacitors may need to withstand extremely high electrical currents, this implies that the section of the electrical and mechanical connection is sufficiently large. It is this requirement which has given birth to the need for a new brazing method of connection, the conventional connection soldering method not being able to stand up to the necessary demands.

To this day, therefore, a mechanical assembly has been used in particular by means of screw. Although this solution has not been described in detail, it is easily understood that it requires numerous machining and assembling operations, and that it is, in fact, less interesting economically.

Furthermore, the connection solution by means of mechanical assembly takes up a volume, which is considerable with respect to the total volume of the capacitor. The users regret that the volume occupied by the connection through mechanical assembly cannot be used for other purposes, for example to accommodate a first piece of greater volume in order to increase the performance of the capacitor.

Other types of connection are known, such as resistance welding or ultrasonic welding, but in particular, the complexity of the geometric shape of the first face of the first piece leads to technical solutions, which are not satisfactory economically.

The invention has as its object a brazing method for, through melting of a connecting agent then solidification of this connecting agent, achieving a mechanical and electrical connection between at least one first face, of a first piece, and at least one second face, of a second piece, said first piece and said second piece being constituents of an electro-technical device.

Welding, brazing and soldering are quite different methods of connection. Welding does not require a connecting agent, whilst brazing and soldering does. Brazing occurs above 450° C., usually much higher such as 800° C. Soldering covers the temperature range below 450° C.

Specifically, the invention relates to a brazing method for, through melting of a connecting agent then solidification of this connecting agent, achieving a mechanical and electrical connection between at least one first face, of a first piece, and at least one second face, of a second piece, said first piece and said second piece being constituents of an electro-technical device,
the first piece being made starting from
   at least one first metallic material in the form of a foil of a given thickness, this first material comprising a main constituent, referred to as the first main constituent, said first metallic material having a defined temperature of complete solidification (solidus), referred to as the first complete solidification temperature, and
   at least one dielectric interfacing material,
the second piece, on the one hand, having, in a direction substantially orthogonal to the second face, a dimension appreciably greater than the thickness of the first metallic material in foil form making up the first piece, and, on the other hand, being composed of a metallic material, referred to as the second metallic material, comprising a main constituent, referred to as the second main constituent, at least substantially similar to the first main constituent of the first metallic material, said second metallic material likewise having a temperature of complete solidification (solidus), also defined, referred to as the second temperature of complete solidification.

According to the invention a connecting agent is used made up beforehand of a metallic material which, referred to as the third metallic material, comprises a main constituent, referred to as the third main constituent, at least substantially similar to the first main constituent, this third metallic material having however a temperature of complete melting (liquidus) which is lower, on the one hand, than the first complete solidification temperature, and, on the other hand, than the second complete solidification temperature.

The invention likewise relates to devices for storage of electrical energy, such as capacitors, primary batteries and secondary batteries, which contain pieces between which a mechanical and electrical connection is achieved according to the aforementioned brazing method.

The invention will be better understood from reading the following description, given by way of non-limiting example, with reference to the attached drawing showing schematically:

FIG. 1: an exploded view and in perspective of an electro-technical device comprising pieces intended to be connected according the inventive brazing method,

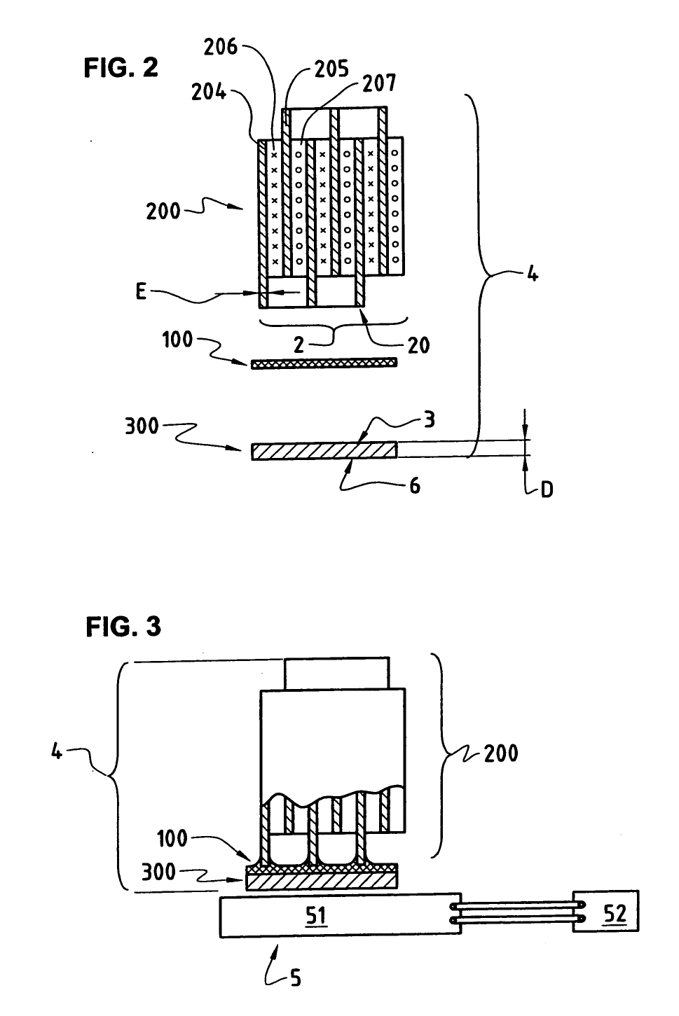

FIG. 2: a view in longitudinal section of an electro-technical device comprising pieces disposed to be connected according to the inventive brazing method,

FIG. 3: a view in partial section of the electro-technical device of FIG. 2 after connection of the pieces, which it comprises by implementing the brazing method according to the invention, by means of an induction-heating device,

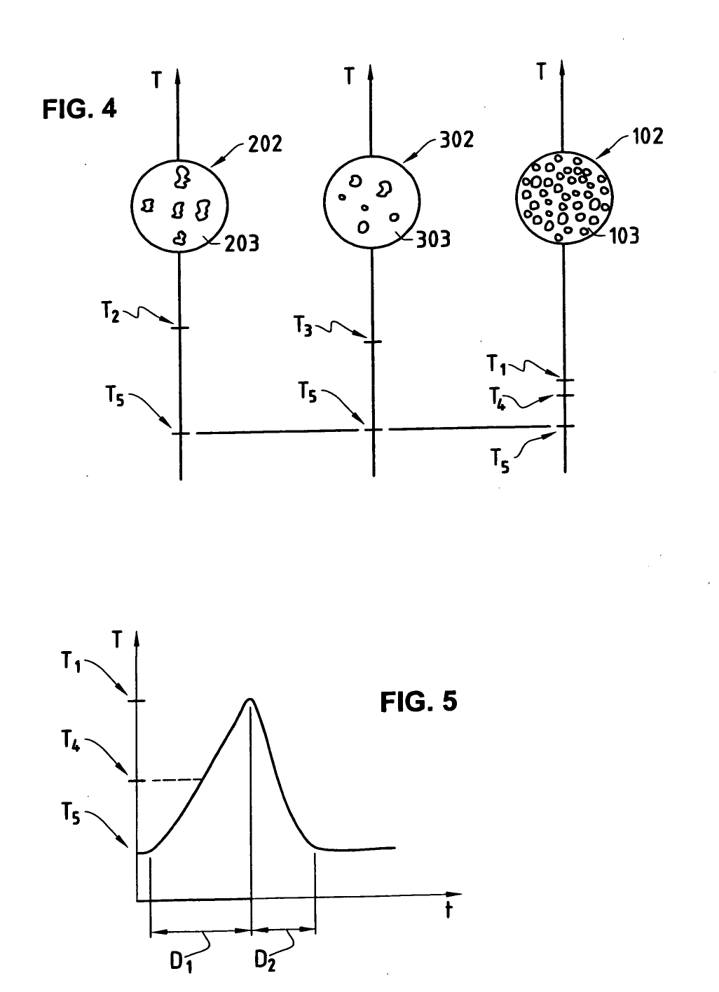

FIG. 4: a temperature graph symbolising, in particular, the temperature values for complete solidification and for complete melting of different materials used to make up and connect the pieces of the electro-technical device of FIGS. 1 to 3,

FIG. 5: a temperature graph symbolising, as a function of time “t”, the development of the temperature “T” of a piece of the electro-technical device of FIGS. 1 to 3 during implementation of the brazing method.

Referring to the drawing, one sees an electro-technical device 4, such as a capacitor, this electro-technical device 4 comprising at least two constituent pieces 200, 300, i.e. a first piece 200 and a second piece 300.

In a general way, it is to be considered that the first piece 200 is made starting from
at least one first metallic material 202, presenting itself in a foil 201 of the thickness E, this first material 202 comprising a main constituent 203, referred to as the first main constituent 203, said first metallic material 202 having a defined temperature of complete solidification (solidus) T2, referred to as the first complete solidification temperature T2, and
at least one dielectric interfacing material 206, 207.

As afore mentioned, a dielectric interfacing material is particularly sensitive to temperature.

The phrase “particularly sensitive to temperature” means that the properties of the dielectric material are altered or even destroyed when its temperature is raised beyond a given value, such as will certainly be reached if the temperature of the beginning of the melting of the first material has been reached or even surpassed.

Likewise in a general way, it is to be considered that the second piece 300, for its part, has, in a direction substantially orthogonal to the second face 3, a dimension D appreciably greater than the thickness E of the first metallic material 202 in foil form 201 making up the first piece 200, and, on the other hand, being composed of a metallic material 302, referred to as the second metallic material 302, comprising a main constituent 303, referred to as the second main constituent 303, at least substantially similar to the first main constituent 203 of the first metallic material 202, said second metallic material 302 likewise having a temperature of complete solidification (solidus) T3, also defined, referred to as the second temperature of complete solidification T3.

In the text, the wording “at least substantially similar” that the said main constituents are, in a non-limitative way, preferably identical to one another.

To achieve a mechanical and electrical connection between at least a first face 2, of the first piece 200, and at least a second face 3, of the second piece 300, one proceeds conventional by melting a connecting agent then solidifying this connecting agent.

However, in a noteworthy way, used is a connecting agent made up beforehand of a metallic material 102 which, referred to as the third metallic material 102, comprises a main constituent 103, referred to as the third main constituent 103, at least substantially similar to the first main constituent 203, this third metallic material 102 having however a temperature of complete melting (liquidus) T1 which is lower, on the one hand, than the first complete solidification temperature T2, and, on the other hand, than the second complete solidification temperature T3.

The different values for the temperatures of complete solidification or of complete melting of the different materials 102, 202, 302 used to make up or connect the pieces of the electro-technical device 4 have been indicated symbolically in a graph (FIG. 4).

This graph contains three parallel axes representing the temperature T and each symbolising one of the first 202, second 302 and third 102 materials.

When studying the graph it will be noted that a circular label has been associated with each line.

Each label symbolises a macroscopic view of the material and bears the marker for said material as well as for its main constituent.

Respecting this first series of technical features makes it possible to ensure that the mechanical and electrical connection obtained between the first piece 200 and the second piece 300 will not generate the phenomenon of corrosion.

In a likewise noteworthy way:

a connecting agent is selected having a defined third complete solidification temperature T4,
with the connecting agent at least one fusible element 100 is constituted able to be placed in contact with at least one of the faces which are the first face 2, of the first piece 200, and the second face 3, of the second piece 300, and
   after having placed the fusible element 100 in contact, at one and the same time, with the first face 2, of the first piece 200, and the second face 3, of the second piece 300, the second piece 300 is heated locally with a predetermined amount of energy, and this for a first duration D1, likewise predetermined, so as to generate firstly solely the melting of the connecting agent, and then secondly the cooling of said connecting agent to a defined temperature lower than the defined third complete solidification temperature T4.

Respecting this second series of technical features makes it possible to ensure that the mechanical and electrical connection to be achieved between the first piece 200 and the second piece 300 will be obtained while preserving the first piece 200 against any thermal degradation.

The fusible element 100 can have different forms, for example, it can comprise:
a filiform element (not shown), for instance, folded according to a shape favouring the distribution of the connecting agent during its melting,
a thin element in foil form (not shown), for example cut having a contour favouring the distribution of the connecting agent during its melting,
a layered pasty element (not shown), for example disposed in the manner of a mould and with a shape favouring the distribution of the connecting agent during its melting,
an element closely connected beforehand to the second piece 300, for example a fusible element 100 constituting part of that second piece 300, for instance when the latter is produced from a bimetallic sheet metal.

As concerns, on the one hand, the value of the energy used for heating the second piece 300, and, on the other hand, the first duration D1 of the heating operation, it is not possible to indicate them exactly, because these values depend upon parameters such as the mass of the pieces, which are not considered here.

One skilled in the art can learn these parameters, in particular of mass, and, through tests, select the value for the energy to be used to heat the second piece 300 and determine the first duration D1 of the heating operation.

One skilled in the art can likewise decide whether the heating is to be carried out in a controlled atmosphere, for instance in an atmosphere of inert gas, or under vacuum.

In a way also noteworthy, the step of heating of the second piece 300 is begun instantaneously starting from a defined ambient temperature T5, without this second piece 300 having to have been heated beforehand in order to bring it to a temperature close to the temperature for complete melting (liquidus) of the connecting agent.

The instantaneous character of the heating and the rapid cooling are two other features of the brazing method according to the invention, which permit the first piece 200 to be protected from thermal degradation.

For the heating, good results have been obtained with temperature increases between twenty-five degrees Celsius per second and one hundred degrees Celsius per second (between 25° C. S⁻¹ and 100° C. S⁻¹).

In a noteworthy way, at the end of the step during which the second piece 300 is heated for a predetermined duration, one proceeds to a controlled cooling of said second piece 300 so as to remove the energy related to the heating, and this in a second predetermined duration D2 so as to prevent any thermal degradation of said first and second pieces 200, 300.

For example, the controlled cooling is carried out by means of a gas jet.

The brazing method according to the invention thus calls for use of a thermal cycle, the effect of which is limited to the zone in which a mechanical and electrical connection are obtained so as to bring about the melting of the connecting agent without thereby exposing the dielectric material directly or indirectly to a temperature which changes or alters it.

According to a known phenomenon, when the temperature for complete melting of the connecting agent is reached, it liquefies and, by capillary action, on one hand, comes to wet different surfaces in which it is placed in contact, and, on the other hand, comes between other surfaces which are facing with a slight spacing.

The complete melting of the connecting agent brings about its distribution.

When cooling, the connecting agent solidifies and ensures the mechanical and electrical connection sought, in particular between the first face 2 of the first piece 200 and the second face 3 of the second piece 300.

In an especially noteworthy way, used is:
a first metallic material 202 having a main constituent 203, referred to as the first main constituent 203, which is of aluminium,
a second metallic material 302 having a main constituent 303, referred to as the second main constituent 303, which is of aluminium, and
a third metallic material 102 consisting of an alloy with a main constituent 103, referred to as the third main constituent 103, which is of aluminium.

Preferably, used is a first metallic material 202 and a second metallic material 302 whose complete solidification temperatures, referred to as first complete solidification temperature T2 and second complete solidification temperature T3, are substantially similar to one another.

The fact that said first complete solidification temperature T2 and said second complete solidification temperature T3 are substantially similar makes it possible to select at least substantially similar metallic materials for the pieces 200, 300, referred to as first 200 and second 300.

In another preferred embodiment, used is a first metallic material 202 and a second metallic material 302 whose complete solidification temperatures, referred to as first complete solidification temperature T2 and second complete solidification temperature T3, are different from one another.

The fact that said first complete solidification temperature T2 and said second complete solidification temperature T3 are different from one another makes it possible to select different metallic materials for the pieces 200, 300, referred to as first 200 and second 300.

In a likewise noteworthy way, used are:
a first metallic material 202 and a second metallic material 302 consisting of aluminium having a complete solidification temperature (solidus), referred to as the first complete solidification temperature T2 which is at least equal to six hundred thirty-five degrees Celsius(635° C.),
a connecting agent consisting of an alloy of aluminium and of silicon with a percentage by mass of silicon which ranges between seven percent and thirteen percent (7% and 13%) silicon and having a complete melting (liquidus) temperature which is at most equal to six hundred thirteen degrees Celsius (613°).

To make up the connecting agent, an aluminium alloy is preferably used whose designation (according to the DIN norm EN 573.3) is of the series AA 4000 (aluminium alloys containing silicon) and whose silicon content ranges between seven percent and thirteen percent (7% and 13%) of silicon.

As is known, the aluminium and its alloys are covered with a layer of aluminium oxide or alumina (Al₂O₃) of greater or lesser thickness, the melting point of which is at about two thousand forty degrees Celsius (2040° C.).

To enable spreading of the connecting agent it is first necessary to remove the layer of aluminium oxide and, to this end, use a fluxing agent, in this case potassium fluoro-aluminate.

This fluxing agent should be reactive in liquid state only that is to say above the temperature of five hundred sixty-five degrees Celsius (565° C.).

Below this temperature, the reactive agent remains inert.

During the heating step, it is first of all the fluxing agent, which melts removing alumina layer from the surface.

During the heating step, it is then the connecting agent, which melts, and when it spreads, it comes into contact with surfaces devoid of oxide, making it possible, by capillary action, to achieve the connection.

During the cooling cycle, the connecting agent solidifies, and thus the mechanical and electrical connection or connections are established.

Preferably, used are a first metallic material 202 and a second metallic material 302 comprising aluminium containing at least one of the elements which are silicon, magnesium, manganese, copper, iron, with percentages by mass which are such that this first metallic material 202 has a complete solidification temperature (solidus), referred to as the first complete solidification temperature T2, which is at least equal to six hundred thirty-five degrees Celsius (635° C.).

Preferably, used are a first metallic material 202 and a second metallic material 302 comprising aluminium containing, in particular, silicon, with a percentage by mass of silicon which ranges between zero point twenty-five and zero point fifty (0.25 and 0.50) and having a complete solidification temperature (solidus), referred to as the first complete solidification temperature T2, which is at least equal to six hundred thirty-five degrees Celsius (635° C.).

As first metallic material 202 and second metallic material 302, a metallic material is preferably used the designation of which (according to the DIN norm EN 573.3) is included in the following series:
AA 1000 (pure aluminium with various degrees of purity),
AA 2000 (aluminium alloys containing copper),
AA 3000 (aluminium alloys containing manganese),
AA 4000 (aluminium alloys containing silicon),
AA 5000 (aluminium alloys containing magnesium),
AA 8000 (aluminium alloys containing iron).

Preferably, the first metallic material 202 and second metallic material 302 are of the AA 1000 series and more specifically AA 1090 or AA 1098, even AA 1099.

The first metallic material 202 consists of aluminium called “pure”, i.e. of aluminium not containing any elements other than impurities.

As has been mentioned, in spite of preconceptions of one skilled in the art, the brazing method according to the invention concerns in particular the field of capacitors; it applies to the achievement of a mechanical and electrical connection through melting of a connecting agent between:
at least one first piece 200 consisting of at least a group of two electrodes separated by at least one element of dielectric interfacing material, at least one of these electrodes being made starting from a foil 201 of a first metallic material 202 of very slight thickness, the grouping of said electrodes being achieved such that at least one of these electrodes has a free edge 20 which extends while thus forming the first face 2 of the first piece 200,
at least one other piece 300, forming an electrical terminal, hereinafter referred to as the second piece 300, intended to be connected mechanically and electrically to the first piece 200, and i.e. to one of the electrodes which it comprises, this second piece 300 being made up such that it has a second face 3 able to be substantially superimposed on the first face 2 of the first piece 200.

As concerns the dielectric interfacing material, which separates the two constituent electrodes of the first piece 200, it can be a matter of foil material, but it can also involve a coating on at least one of the faces of a constituent sheet of material of each electrode.

As has been mentioned, the first piece 200 is made up starting from at least a first metallic material 202 consisting of a foil of aluminium, that is to say that when said first piece comprises electrodes, at least one of these electrodes is made starting from aluminium.

The fact that these electrodes are composed of a foil material does not exclude the faces of these foils being treated, i.e. bearing deposits or other substances. For example, metallic materials 202 and 203 may comprise one or more layer.

As has been mentioned, without being limiting, the brazing method according to the invention applies preferably to:
on the one hand, of a first piece 200 made up by making a cylindrical winding in spiral form by means of at least four superimposed bands 204, 205, 206, 207, of which
   a first band 204 taken from the foil 201 made up of a first metallic material 202,
   a second band 205 likewise taken from the foil 201 made up of a first metallic material 202,
   a third band 206 and a fourth band 207 made up of a dielectric interfacing material,
the winding being achieved in such a way that the first band has a free edge 20 which extends in a spiral thus forming the first face 2 of the first piece 200, and
on the other hand, a second piece 300 made up in such a way that it has a second face 3 able to be substantially superimposed on the first face 2 of the first piece 200.

In the drawings, the second piece 300 is represented as a flat and circular piece, but this is not limiting because other shapes are suitable.

Such a piece can be obtained by cutting, machining or other techniques without this being limiting for the invention.

Likewise, the second piece 300 can be a housing provided a hollow piece having a substantially tubular wall and a bottom to which the first piece 200 can be connected.

In this case, the second piece 300 can be obtained by stamping, extrusion, embossing techniques, without this being limiting for the invention.

One skilled in the art will know how to select the material suitable for achieving the second piece 300.

In a noteworthy way, to heat locally the second piece 300 with a predetermined amount of energy, and this for a first duration D1, likewise predetermined, so as to generate firstly solely the melting of the connecting agent of the fusible element 100, then, secondly, the cooling of said connecting agent, an induction heating device 5 is used having an induction coil 51 and an apparatus 52 for supplying the induction coil with power, of determined frequency.

As is apparent from the drawing, the second piece 300 has a free face 6, which is substantially opposite said second face 3.

Preferably, the induction coil 51 has a receiving face, which is substantially flat.

The second piece 300 is placed at a predetermined distance above the receiving face of the induction coil 51, and this by its free face 6.

The first piece 200 abuts, for its part, the second piece 300, i.e. the face referred to as the first face 2 of the first piece 200 co-operates with the face referred to as the second face 3 of the second piece 300.

In noteworthy way, when heating the second piece 300, the piece is set in rotation above the induction coil 51 in such a way as to distribute the heat supply.

In a noteworthy way, when heating the second piece 300 the first piece 200 is forced against the second piece 300.

This procedure allows the faces to be assembled, i.e. the first face 2 and the second face 3, to be put together perfectly while compensating for possible irregularities of these faces.

According to another embodiment, to heat locally the second piece 300 with a predetermined amount of energy, and this for a first duration D1, likewise predetermined, so as to generate firstly solely the melting of the connecting agent of the fusible element 100, then, secondly, the cooling of said connecting agent, a heating device is used employing an electromagnetic field.

According to another embodiment, the heating device may also consist in a laser beam (Laser heating).

In this case, the light beam is used to sweep a face 6 of the second piece 300, which is opposite the second face 3 at the level at which the connection with the first piece 200 is to be achieved.

The heat is transported by conduction in depth in the second piece 300, which causes the melting of the connecting agent, and, as a consequence, makes it possible to achieve the connection between the first piece 200 and the second piece 300.

Any other heat source can also be suitable that allows rapid and very localised heating of the second piece 300; for example, an electron-beam can be implemented, or a light beam other than laser light, or even a flame, or molten metal bath.

The invention also relates to electro-technical devices comprising at least one first piece and at least one second piece 300 between which a mechanical and electrical connection is achieved according to the aforementioned brazing method.

In a noteworthy way, the second piece 300 defines a housing.

In a noteworthy way, the first piece 200 is a capacitor electrode.

In a noteworthy way, the first piece 200 is a battery electrode.

In a noteworthy way, the first piece 200 comprises carbon particles.

In a noteworthy way, the capacitor electrode is a double-layer capacitor electrode.

1-21. (canceled)

22. Brazing method for, through melting of a connecting agent then solidification of this connecting agent, achieving a mechanical and electrical connection between at least one first face, of a first piece, and at least one second face, of a second piece, said first piece and said second piece being constituents of an electro-technical device,
the first piece being made starting from
at least one first metallic material in the form of a foil of a given thickness, this first material comprising a main constituent, referred to as the first main constituent, said first metallic material having a defined temperature of complete solidification (solidus), referred to as the first complete solidification temperature and
at least one dielectric interfacing material,
the second piece, on the one hand, having, in a direction substantially orthogonal to the second face, a dimension appreciably greater than the thickness of the first metallic material in foil form making up the first piece, and, on the other hand, being composed of a metallic material, referred to as the second metallic material, comprising a main constituent, referred to as the second main constituent, at least substantially similar to the first main constituent of the first metallic material, said second metallic material likewise having a temperature of complete solidification (solidus), also defined, referred to as the second temperature of complete solidification,
this brazing method being characterised in that used is a connecting agent made up beforehand of a metallic material which, referred to as the third metallic material, comprises a main constituent, referred to as the third main constituent, at least substantially similar to the first main constituent, this third metallic material having however a temperature of complete melting (liquidus) which is lower, on the one hand, than the first complete solidification temperature, and, on the other hand, than the second complete solidification temperature.

23. Brazing method according to claim 22, characterised in that:
chosen is a connecting agent having a defined third complete solidification temperature,
with the connecting agent at least one fusible element is constituted able to be placed in contact with at least one of the faces which are the first face, of the first piece, and the second face, of the second piece, and
after having placed the fusible element in contact, at one and the same time, with the first face, of the first piece, and the second face, of the second piece, the second piece is heated locally with a predetermined amount of energy, and this for a first duration, likewise predetermined, so as to generate firstly solely the melting of the connecting agent, and then secondly the cooling of said connecting agent to a defined temperature lower than the defined third complete solidification temperature.

24. Brazing method according to claim 22, characterised in that the step of heating of the second piece is begun instantaneously starting from a defined ambient temperature, without this second piece having to have been heated beforehand in order to bring it to a temperature close to the temperature for complete melting (liquidus) of the connecting agent.

25. Brazing method according to claim 22, characterised in that at the end of the step during which the second piece is heated for a predetermined duration, one proceeds to a controlled cooling of said second piece so as to remove the energy related to the heating, and this in a second predetermined duration so as to prevent any thermal degradation of said first and second pieces.

26. Brazing method according to claim 22, characterised in that it uses:
a first metallic material having a main constituent, referred to as the first main constituent, which is of aluminium,
a second metallic material having a main constituent, referred to as the second main constituent, which is of aluminium, and
a third metallic material consisting of an alloy with a main constituent, referred to as the third main constituent, which is of aluminium.

27. Brazing method according to claim 22, characterised in that used is a first metallic material and a second metallic material whose complete solidification temperatures, referred to as first complete solidification temperature and second complete solidification temperature, are at least substantially similar to one another.

28. Brazing method according to claim 22, characterised in that used is a first metallic material and a second metallic material whose complete solidification temperatures, referred to as first complete solidification temperature and second complete solidification temperature, are different from one another.

29. Brazing method according to claim 22, characterised in that it uses:
a first metallic material and a second metallic material consisting of aluminium having a complete solidification temperature (solidus), referred to as the first complete solidification temperature which is at least equal to six hundred thirty-five degrees Celsius (635° C.),
a connecting agent consisting of an alloy of aluminium and of silicon with a percentage by mass of silicon which ranges between seven percent and thirteen percent (7% and 13%) silicon and having a complete melting (liquidus) temperature which is at most equal to six hundred thirteen degrees Celsius (613°).

30. Brazing method according to claim 22, characterised in that it uses a first metallic material and a second metallic material comprising aluminium containing at least one of the elements which are silicon, magnesium, manganese, copper, iron, with percentages by mass which are such that this first metallic material has a complete solidification temperature (solidus), referred to as the first complete solidification temperature, which is at least equal to six hundred thirty-five degrees Celsius (635° C.).

31. Brazing method according to claim 22, characterised in that it uses a first metallic material and a second metallic material comprising aluminium containing, in particular, silicon, with a percentage by mass of silicon which ranges between zero point twenty-five and zero point fifty (0.25 and 0.50) and having a complete solidification temperature (solidus), referred to as the first complete solidification temperature, which is at least equal to six hundred thirty-five degrees Celsius (635° C.).

32. Brazing method according to claim 22, characterised in that it uses:
at least one first piece consisting of at least a group of two electrodes separated by at least one element of dielectric interfacing material, at least one of these electrodes being made starting from a foil of a first metallic material of very slight thickness, the grouping of said electrodes being achieved such that at least one of these electrodes has a free edge which extends while thus forming the first face of the first piece,
at least one other piece, forming an electrical terminal, hereinafter referred to as the second piece, intended to be connected mechanically and electrically to the first piece, and i.e. to one of the electrodes which it comprises, this second piece being made up such that it has a second face able to be substantially superimposed on the first face of the first piece.

33. Brazing method according to claim 22, characterised in that to heat locally the second piece with a predetermined amount of energy, and this for a first duration, likewise predetermined, so as to generate firstly solely the melting of the connecting agent of the fusible element, then, secondly, the cooling of said connecting agent, an induction heating device is used having an induction coil and an apparatus for supplying the induction coil with power, of determined frequency.

34. Brazing method according to claim 22, characterised in that to heat locally the second piece with a predetermined amount of energy, and this for a first duration, likewise predetermined, so as to generate firstly solely the melting of the connecting agent of the fusible element, then, secondly, the cooling of said connecting agent, a heating device is used employing an electromagnetic field.

35. Brazing method according to claim 33, characterised in that when heating the second piece, the piece is set in rotation on the induction coil in such a way as to make the heating uniform.

36. Brazing method according to claim 22, characterised in that when heating the second piece the first piece is forced against the second piece.

37. Electro-technical devices comprising at least one first piece and at least one second piece between which a mechanical and electrical connection is achieved according to the brazing method of claim 22.

38. The electro-technical device of claim 37, where the second piece defines a housing.

39. The electro-technical device of claim 38, where the first piece is a capacitor electrode.

40. The electro-technical device of claim 38, where the first piece is a battery electrode.

41. The electro-technical device, of claim 39, where the first piece comprises carbon particles.

42. The electro-technical device of claim 39, where the capacitor electrode is a double-layer capacitor electrode.
